(19) United States
(12) Patent Application Publication
(10) Pub. No.: US 2026/0274008 A1
(43) Pub. Date: Sep. 17, 2026

(54) PNEUMATIC VEHICLE TIRE

(71) Applicant: Continental Reifen Deutschland GmbH, Hannover (DE)

(72) Inventors: Manickaraj Subramanian Sivanarutchelvi, Garbsen (DE); Jürgen Brockmann, Hannover (DE); Torsten Heinhaupt, Celle (DE); Matthias Seng, Hannover (DE); Claudia Bauer, Bad Nenndorf (DE); Christian Brandau, Bad Nenndorf (DE); Artur Fuchs, Hannover (DE)

(73) Assignee: Continental Reifen Deutschland GmbH, Hannover (DE)

(21) Appl. No.: 19/162,224

(22) PCT Filed: Mar. 21, 2024
(86) PCT No.: PCT/EP2024/057535

§ 371 Date: Sep. 4, 2025

(30) Foreign Application Priority Data
Mar. 24, 2023 (DE) 10 2023 202 718.6

(51) Int. Cl. B60C 11/03; B60C 11/12

(52) U.S. Cl. CPC B60C 11/0311; B60C 11/1204; B60C 11/1236; B60C 11/1272; B60C 2011/0313

(57) ABSTRACT

A pneumatic vehicle tire having a directional tread having profile blocks or profile-block like profile structures which are provided with at least two sipes extending parallel to one another as seen in plan view, which sipes have a width of 0.40 mm to 1.00 mm and, at least within a central sipe portion present along their longitudinal extent in the profile block or the block-like profile structure, have, starting from the sipe base, a radially inner and, adjacent to this, a radially outer portion. In the tread, profile blocks or block-like profile structures having at least one pair of sipes running adjacent to one another are present whose radially inner portions run in the radial direction and whose radially outer portions, in each case starting from their radially inner end, are inclined with respect to the radial direction toward the leading edge.

The invention relates to a pneumatic vehicle tire having a directional tread having profile blocks or block-like profile structures which, at the tread periphery in the case of grooves, such as transverse grooves or oblique grooves, have leading edges which enter the ground contact patch first during rolling of the tire during forward travel and trailing edges opposite these leading edges, and are provided with at least two sipes extending parallel to one another as seen in plan view, which sipes each have a width of 0.40 mm to 1.00 mm and, within a central sipe portion present along their longitudinal extent in the profile block or the block-like profile structure, have, starting from the sipe base, a radially inner and, adjacent to this, a radially outer portion, wherein the radially outer portion runs at an angle of 5° to 35° to the radial direction.

A pneumatic vehicle tire of this type is known, for example, from WO 2017/213230A1 . The tread of this tire has profile blocks each having a number of sipes which extend in the axial direction and which, in the radial direction, beginning at the sipe base, are composed of two sipe portions which are inclined with respect to the radial direction, wherein their angles of inclination with respect to the tread periphery are opposite. In each profile block there are at least four sipes which have correspondingly inclined sipe portions or are designed such that the bends between the two sipe portions of one half of the sipes face the bends between the sipe portions of the second half of the sipes.

Tires having treads having such profile blocks are intended above all to have a good ice performance and can be easily demolded after vulcanization in a vulcanization mold.

Further pneumatic vehicle tires having treads having profile blocks having sipes which have two portions in the radial direction which enclose an obtuse angle with one another and of which one is a portion running in the radial direction starting from the sipe base and the second is a portion adjoining the first and running at an inclination with respect to the radial direction at an acute angle in the direction of the tread periphery are known from DE 10 2019 206 591 A1 and DE 10 2019 206 592 A1 . Tires having treads having profile blocks having sipes configured in such a way are intended above all to be improved in terms of the aquaplaning properties and the braking properties on dry roads and to have good snow performance.

Sipes having radially outer portions running in the region of the tread periphery at an acute angle to the radial direction improve snow grip and braking performance on dry roads due to the angle of engagement present in the tread periphery and reduce rolling-in effects at the associated sipe edge on the profile surface. In addition, wear is also reduced by a reduced snap-out effect under traction. Depending on the local stiffness of the individual block segments formed by the sipes, such sipes have different effects. In particular in pneumatic vehicle tires which have directional tread profiles, a different wear of the block segments can occur, which, for example by sawtooth formation, causes undesirable noise phenomena.

The invention is therefore based on the object of further ensuring the aforementioned positive effects of the sipes in a pneumatic vehicle tire of the type stated at the outset having a directional tread profile, wherein locally different wear of block segments, in particular also to avoid undesirable noise phenomena, such as certain audible frequencies in the rolling noise, is to be prevented.

According to the invention, the set object is achieved in that, in the tread, profile blocks or block-like profile structures having at least one pair of sipes running adjacent to one another are present, whose radially inner portions run in the radial direction and whose radially outer portions, in each case starting from their radially inner end, are inclined with respect to the radial direction toward the leading edge, wherein in that sipe which is situated closer to the leading edge, the radially outer portion encloses an angle with the radial direction which is larger by at least 3°, in particular by at least 5°, than the radially outer portion of the other sipe.

The invention allows the wear of block segments, which are formed by sipes, in the profile blocks or segments in the block-like profile structures to be evened out, in particular by the different inclination of the radially outer portions of the sipes and the inclination in the same direction of these portions with respect to the leading edges. As a result, undesirable noise phenomena in the rolling noise can also be largely avoided. Advantageously, the tire can moreover react particularly well to lateral forces when changing lanes or cornering as a result of these measures.

In a preferred embodiment of the invention, the pairs of sipes are in each case the only sipes in profile blocks or block-like profile structures of the tread. In directional treads, the circumferential and lateral stiffness of the individual block segments can be particularly advantageously influenced in certain tread regions, for example in the central tread region, by having two sipes in the profile blocks or in the block-like profile structures, with regard to supporting uniform wear or in respect of achieving an exact force transfer for steering forces.

In further, advantageous embodiments, at least in each case a further sipe is present in profile blocks or block-like profile structures which has a radially inner portion, which runs in the radial direction, and a radially outer portion, which, in each case starting from its radially inner end, runs at an inclination with respect to the radial direction toward the leading edge.

In this case, profile blocks or block-like structures may be present in the tread, in which blocks or structures a further sipe situated closer to the leading edge is formed, wherein in this case the radially outer portion of the further sipe runs at an angle to the radial direction which at least corresponds to the angle of the radially outer portion, also relative to the radial direction, of that sipe which, of the pair of sipes, is closer to the leading edge.

If, according to a further advantageous embodiment, profile blocks or block-like profile structures having at least one further sipe situated closer to the trailing edge are present in the tread, it is advantageous if the radially outer portion of the further sipe runs at an angle to the radial direction which at most corresponds to the angle of the radially outer portion of that sipe which, of the pair of sipes, is closer to the trailing edge.

The further sipes are therefore advantageously formed in such a way that, in the directional configuration of the tread, they support uniform wear of the profile blocks or block-like profile structures.

In this case of more than two sipes in profile blocks or block-like profile structures, a sipe which has no outer portion inclined with respect to the radial direction may also run in particular adjacent to the trailing edge.

In tread configurations with profile blocks or block-like profile structures with relatively large circumferential lengths, embodiment variants in which up to three further sipes are present are possible and advantageous.

For uniform wear of profile blocks or block-like profile structures in the tread, it can also be particularly advantageous if the angle of the radially outer portions from sipe to sipe, beginning at the radially outer portion of the sipe adjacent to the leading edge, becomes smaller in the direction of the trailing edge.

For the action of the sipes with regard to evening out the wear, it is further advantageous if, in sipes with outer portions running at an inclination with respect to the radial direction, these portions each enclose an angle in the range of 5° to 25° with the radial direction, wherein in a preferred embodiment the angle of the radially outer portion in the sipe closest or adjacent to the leading edge is 15° to 23°, in particular 17° to 23°, preferably 20°, and the angle of the radially outer portion in the sipe closest or adjacent to the trailing edge is 7° to 13°, in particular 10°.

Particularly effective are radially outer portions in the respective sipes which, determined from the tread periphery, each extend to a depth of 1.50 mm to 3.50 mm, in particular from 2.00 mm to 3.50 mm and preferably from 2.50 mm to 3.50 mm.

Typically, sipes running in profile blocks or block-like profile structures open into a groove at least with their one end. In particular in the region of the openings into grooves, it is advantageous if the sipes each have an edge portion which, determined from the tread periphery, in each case extends to a depth which is lower than the depth of the central sipe portion. The edge portions can extend to different depths; in preferred embodiments, they extend, determined from the tread periphery, to a depth of 10% to 50% of the profile depth.

In a further embodiment, the sipes each have a transition portion which starts from the tread periphery and runs in the radial direction and extends to a depth of 0.20 mm to 0.50 mm. These very shallow transition portions are formed by corresponding portions on the metal blades forming the sipes during the vulcanization of the tire in a vulcanization mold, wherein these blade portions are used to demold the tread after vulcanization in the region of the sipes in a particular clean manner and without tears.

Further features, advantages and details of the invention will now be described in more detail with reference to the schematic and simplified drawing, which shows an exemplary embodiment of the invention. In the drawings:

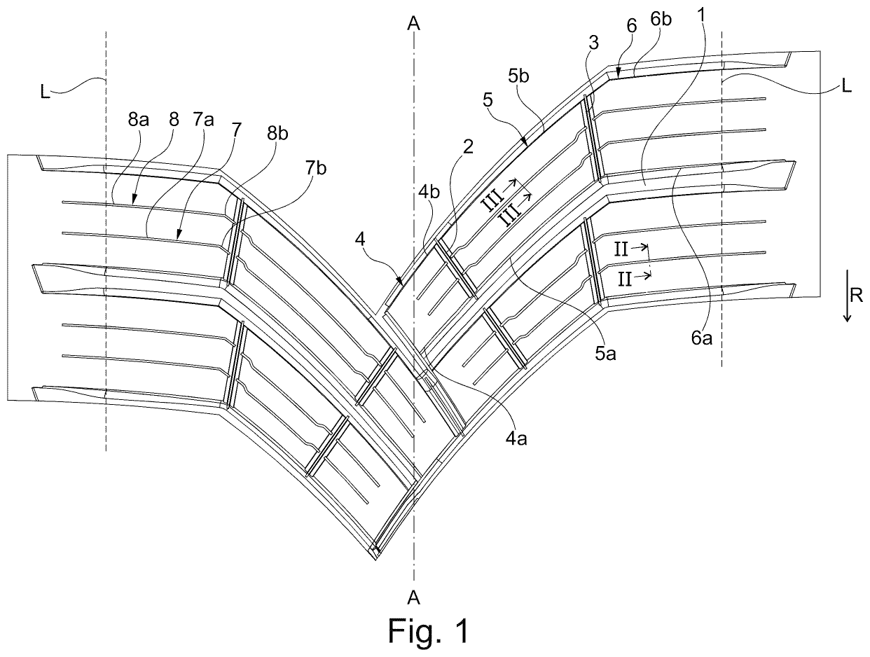

FIG. 1 shows a plan view of a detail of a circumferential portion of a tread of a pneumatic vehicle tire with an embodiment variant of the invention,

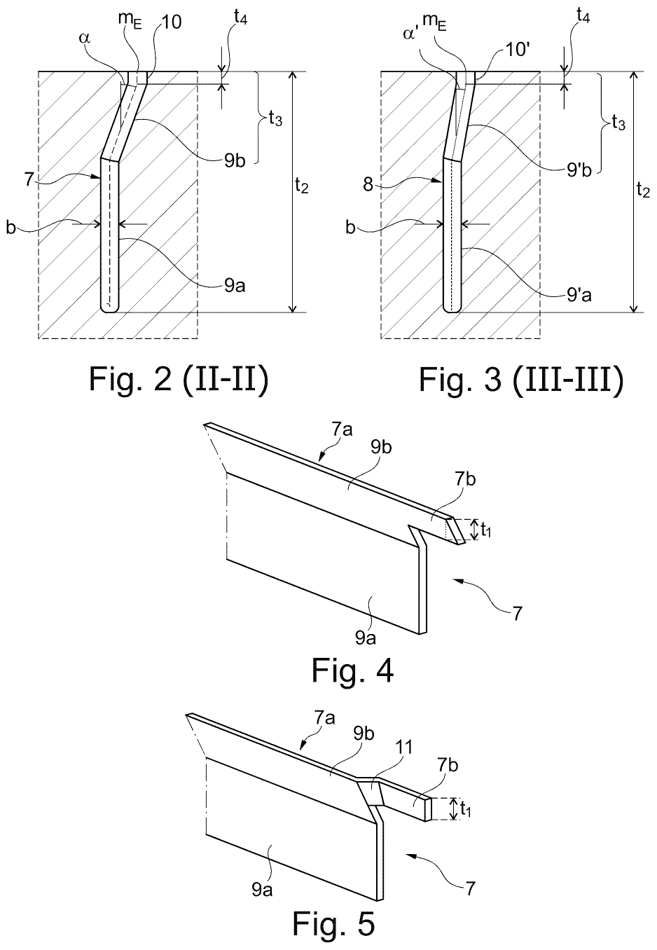

FIG. 2 shows an enlarged sectional illustration along the line II-II of FIG. 1,

FIG. 3 shows an enlarged sectional illustration along the line III-III of FIG. 1,

FIG. 4 and FIG. 5 show visualizations (subtraction solids) of sipe portions.

Pneumatic vehicle tires designed according to the invention are tires for motor vehicles, in particular for multi-track motor vehicles, preferably tires of radial design for cars, vans, SUVs or light trucks (having a maximum permissible weight ≤7.5 t).

FIG. 1 shows a plan view of a circumferential portion of a tread belonging to a pneumatic vehicle tire having a directional profiling, such that the pneumatic vehicle tire is to be mounted on the vehicle in such a way that it has the rolling direction, indicated by the arrow R, during forward travel. The line A-A denotes the tire equatorial plane of the tire, and the two lateral edges of the ground contact area of the tread are each denoted by a line L.

In the embodiment shown, the tread has in each tread half oblique grooves 1 which, as seen in plan view, run parallel to one another and are slightly curved in portions, which oblique grooves, starting from the region of the tire equatorial plane A-A, extend to beyond the lateral edges L and overall run in a substantially V-shaped manner and offset to one another in the circumferential direction in the tread halves over the width of the tread. Over the most part of their extent, the oblique grooves 1 are preferably configured to the respectively provided profile depth of in particular 6.0 mm to 9.5 mm and are the main (drainage) grooves of the tread. The term profile depth refers, as usual, to the depth of the deepest main grooves on a new tire.

The end of each oblique groove 1 toward the inner side of the tread opens in each case into an oblique groove 1 running in the other tread half. Running between the oblique grooves 1, which are adjacent in the circumferential direction, are in each case two connecting grooves 2, 3 which are inclined with respect to the circumferential direction in opposite directions to the oblique grooves 1 and have a depth in the order of magnitude of 30% to 70% of the profile depth. The connecting grooves 3 each run at an acute angle of 5° to 15° to the circumferential direction, the connecting grooves 3′ at an angle of 30° to 45°.

Together with the connecting grooves 3, 3′, the oblique grooves 1 divide the tread into central profile blocks 4, semi-central profile blocks 5 and into shoulder-side profile blocks 6. The oblique grooves 1 extend in the region of the central profile blocks 4 and the semi-central profile blocks 5 in plan view in particular at an angle of 30° up to 50° to the axial direction and in the region of the shoulder-side profile blocks 6 at an angle of 0° to 20° to the axial direction. In an alternative embodiment, for example, the central and the semi-central profile blocks are connected to form block-like profile structures.

Each profile block 4, 5 and 6 has at the tread periphery a leading edge 4a, 5a and 6a formed on the one adjacent oblique groove 1 and a trailing edge 4b, 5b and 6b formed on the other adjacent oblique groove 1. The leading edges 4a, 5a, 6a of a block 4, 5 and 6 are those block edges which enter the ground contact patch first during rolling of the tire during forward travel (arrow R).

The profile blocks 4, 5 and 6 or the block-like profile structures repeat themselves over the circumference of the tread, except for various adaptations as a result of the application of a method of pitch length variation.

As shown in FIG. 1, in each case two sipes 7, 8 are formed in the profile blocks 4, 5 and 6 shown. All sipes 7, 8 preferably run parallel or substantially parallel to the oblique grooves 1 and parallel to one another within the profile blocks 4, 5 and 6. The sipes 7 are the sipes adjacent to the respective leading edge 4a, 5a, 6a, and the sipes 8 are the sipes adjacent to the respective trailing edge 4b, 5b, 6b.

In each case considered in plan view and along their extent, the sipes 7, 8 preferably run straight or substantially straight and preferably crossing the respective profile block 4, 5, 6, and have in plan view in their extent central sipe portions 7a, 8a and, opposite to these, shallower edge portions 7b, 8b which, starting from the tread periphery, extend to a depth t₁ (FIG. 4, FIG. 5) of 10% to 50% of the profile depth. The central sipe portions 7a, 8a extend over 70% to 95% of the longitudinal extent of the sipes 7, 8, wherein this longitudinal extent in the shoulder-side profile blocks 6 is determined from the lateral edges L, and the sipes 7, 8 in the shoulder-side profile blocks 6 each have only one edge portion 7b, 8b. In the central profile blocks 4, the sipes 7, 8 end within the profile blocks 4 in the exemplary embodiment shown. The central sipe portions 7a, 8a extend in the radial direction, starting from the tread periphery and optionally up to places with local base elevations, to a depth t₂ (FIG. 2, FIG. 3) of 60% to 95% of the profile depth.

In each profile block 4, 5 and 6, the two sipes 7, 8 are arranged in particular in such a way that they have substantially equal distances from one other and from the respectively adjacent block edges 4a, 5a, 6a and 4b, 5b and 6b, so that the arrangement of the sipes 7, 8 in each profile block 4, 5 and 6 corresponds substantially to a uniform arrangement.

FIG. 2 and FIG. 3 use the example of a sipe 7 in a profile block 6 and a sipe 8 of a profile block 5 (the following description applies analogously to the sipes 7, 8 in the further profile blocks 4, 5 and 6) to show radial cross sections from central sipe portions 7a, 8a. Perpendicular to the drawn sipe center line m_{E}, the sipes 7, 8 have an in particular constant width b of 0.40 mm to 1.00 mm, preferably of up to 0.80 mm. Considered in the radial direction, each central sipe portion 7a, 8a, starting from the sipe base, is composed of a radially inner portion 9a, 9′a running in the radial direction, a radially outer portion 9b, 9′b adjoining the latter, and a transition portion 10, 10′ running to the tread periphery. The radially outer portion 9b in a sipe 7 runs at an acute angle α (FIG. 2) to the radial direction, and the radially outer portion 9′b in a sipe 8 runs at an acute angle α′ (FIG. 3), in each case to a depth t₃, determined from the tread periphery, of 1.50 mm to 3.50 mm, preferably of 2.00 mm to 3.50 mm, particularly preferably of 2.50 to 3.50 mm. Each transition portion 10, 10′ is a short portion which, running in the radial direction starting from the tread periphery, extends to a depth t₄ of 0.20 mm to 0.50 mm. In any case, the radially outer portion 9b, 9′b and the transition portion 10, 10′ are situated at a point with a possible local base elevation.

In the sipes 7, the angle α of the radially outer portions 9b relative to the radial direction is 15° to 23°, preferably 20°, and in the sipes 8, the angle α′ of the radially outer portions 9′b is 7° to 13°, in particular and preferably 10°. The radially outer portion 9b in the sipes 7 encloses with the radial direction an angle of at least 3°, in particular at least 5°, greater than the radially outer portion 9′b in the sipe 8. The inclination directions of the radially outer portions 9b, 9′b in the sipes 7, 8 are the same and such that the portions 9b, 9′b, starting from their radially inner ends, are each inclined in the direction of the leading block edge 4a, 5a, 6a. The radially outer portions 9b, 9′b in the sipes 7, 8 therefore move away with increasing depth from the respective leading edge 4a, 5a, 6a.

FIG. 4 shows, for example, by means of a visualization of a portion of a sipe 7, a partial region of the central sipe portion 7a with an embodiment variant of the edge portion 7b adjacent thereto. In the edge portion 7b, which is designed to be shallower than the radially outer portion 9b, which is inclined at the angle α to the radial direction, its inclination is continued; therefore, the edge portion 7b also runs at the angle α to the radial direction.

FIG. 5 shows a variant of the embodiment of an edge portion 7a, also by means of a visualization of a portion of the sipe portion 7a of a sipe 7. There are illustrated a partial region of the central sipe portion 7a and the adjacent, shallow edge portion 7b, which is oriented here in the radial direction and is connected to these portions via a connecting portion 11 which runs at obtuse angles to the central sipe portion 7a and to the edge portion 7b.

In FIG. 4 and FIG. 5, the transition portions 10 have been omitted. The drawn depth t₁ here refers only to the edge portion 7b.

In alternative embodiments, which are not shown separately, the tread contains profile blocks or block-like profile structures in which more than two sipes, in particular three to five sipes, are formed.

Examples of such variants are:

### For Three Sipes

Examples of angle sequences of the radially outer portions of the sipes, beginning at the sipe following the leading block edge:
20°, 20°, 10° or 20°, 15°, 10° or 20°, 10°, 0°.

### For Four Sipes

Examples of angle sequences of the radially outer portions of the sipes, beginning at the sipe following the leading block edge:
20°, 15°, 10°, 0° or 20°, 20°, 15°, 10° or 20°, 15°, 10°, 10°.

Sipe portions running in the radial direction are also to be understood as meaning those portions which are oriented at an angle of up to 3° to the radial direction. The sipes in the profile blocks can further extend to the leading and trailing edges at in particular acute angles.

### LIST OF REFERENCE SIGNS

1 . . . Oblique groove
2,3 . . . Connecting groove
4 . . . Central profile block
5 . . . Semi-central profile block
6 . . . Shoulder-side profile block
4a, 5a, 6a . . . Leading edge
4b, 5b, 6b . . . Trailing edge
7 . . . Sipe (at leading edge)
7a . . . Central sipe portion
7b . . . Edge portion
8 . . . Sipe (at trailing edge)
8a . . . Central sipe portion
8b . . . Edge portion
9a . . . Radially inner portion (sipe 7)
9′a. . . Radially inner portion (sipe 8)
9b . . . Radially outer portion (sipe 7)
9′b. . . Radially outer portion (sipe 8)
10 . . . Transition portion (sipe 7)
10′. . . Transition portion (sipe 8)
11 . . . Connecting portion
α. . . Angle (at 9b)
α′. . . Angle (at 9′b)
b . . . Width of the sipes 7, 8
L . . . Lateral edge
m_{E}. . . Sipe center line
R . . . Rolling direction during forward travel
t₁. . . Depth (edge portions 7b, 8b)
t₂. . . Depth (central sipe portions 7a, 8a)
t₃. . . Depth (radially outer portion 9b, 9′b)
t₄. . . Depth (transition portion 10, 10′)

1. A pneumatic vehicle tire having a directional tread having profile blocks or profile block-like profile structures which, at the tread periphery in the case of grooves, such as transverse grooves or oblique grooves, have leading edges which enter the ground contact patch first during rolling of the tire during forward travel and trailing edges opposite these leading edges, and are provided with at least two sipes extending parallel to one another as seen in plan view, which sipes have a width of 0.40 mm to 1.00 mm and, at least within a central sipe portion present along their longitudinal extent in the profile block or the block-like profile structure, have, starting from the sipe base, a radially inner and, adjacent to this, a radially outer portion, wherein the radially outer portion runs at an angle of 5° to 35° to the radial direction,
wherein
in the tread, profile blocks or block-like profile structures having at least one pair of sipes running adjacent to one another are present, whose radially inner portions run in the radial direction and whose radially outer portions, in each case starting from their radially inner end, are inclined with respect to the radial direction toward the leading edge, wherein in that sipe which is situated closer to the leading edge, the radially outer portion encloses an angle with the radial direction which is larger by at least 3°, than the radially outer portion of the other sipe.

2. The pneumatic vehicle tire as claimed in claim 1, wherein the pairs of sipes are the only sipes in profile blocks or block-like profile structures of the tread.

3. The pneumatic vehicle tire as claimed in claim 1, wherein, in the tread, profile blocks or block-like profile structures having at least one further sipe situated closer to the leading edge are present, wherein the radially outer portion of the further sipe runs at an angle in the radial direction which corresponds at least to the angle of the radially outer portion of that sipe which, of the pair of sipes, is closer to the leading edge.

4. The pneumatic vehicle tire as claimed in claim 1, wherein, in the tread, profile blocks or block-like profile structures having at least one further sipe situated closer to the trailing edge are present, wherein the radially outer portion of the further sipe runs at an angle to the radial direction which corresponds at most to the angle of the radially outer portion of that sipe which, of the pair of sipes, is closer to the trailing edge.

5. The pneumatic vehicle tire as claimed in claim 1, wherein, in the tread, profile blocks or block-like profile structures are present in which a sipe which has no outer portion inclined with respect to the radial direction runs adjacent to the trailing edge.

6. The pneumatic vehicle tires as claimed in claim 1, wherein, in the tread, profile blocks or block-like profile structures having up to three further sipes are present.

7. The pneumatic vehicle tire as claimed in claim 1, wherein the angle of the radially outer portions from sipe to sipe, beginning at the radially outer portion of the sipe adjacent to the leading edge, becomes smaller in the direction of the trailing edge.

8. The pneumatic vehicle tire as claimed in claim 1, wherein, in sipes having outer portions running at an inclination with respect to the radial direction, these portions each enclose an angle in the range from 5° to 25° with the radial direction.

9. The pneumatic vehicle tire as claimed in claim 1, wherein the angle of the radially outer portion of the sipe situated closest or adjacent to the leading edge is 15° to 23°, in particular 17° to 23°, preferably 20°, and in the sipe situated closest or adjacent to the trailing edge is 7° to 13°, in particular 10°.

10. The pneumatic vehicle tire as claimed in claim 1, wherein the radially outer portions, determined from the tread periphery, each extend to a depth of 1.50 mm to 3.50 mm, in particular from 2.00 mm to 3.50 mm and preferably from 2.50 mm to 3.50 mm.

11. The pneumatic vehicle tire as claimed in claim 1, wherein the sipes have at least one edge portion which, determined from the tread periphery, extends in each case to a depth which is lower than the depth of the central sipe portion.

12. The pneumatic vehicle tire as claimed in claim 11, wherein the edge portions, determined from the tread periphery, extend to a depth of 10% to 50% of the profile depth.

13. The pneumatic vehicle tire as claimed in claim 1, wherein the sipes each have a transition portion which starts from the tread periphery and runs in the radial direction and extends to a depth of 0.20 mm to 0.50 mm.
